(19) United States
(12) Patent Application Publication
(10) Pub. No.: US 2026/0005638 A1
(43) Pub. Date: Jan. 1, 2026

(54) MOTOR DRIVING APPARATUS AND METHOD FOR CONTROLLING THE SAME

(71) Applicants: Hyundai Motor Company, Seoul (KR); Kia Corporation, Seoul (KR)

(72) Inventors: Jae Ho HWANG, Hwaseong-si (KR); Hong Geuk PARK, Hwaseong-si (KR); Yong Jae LEE, Hwaseong-si (KR); Min KIM, Hwaseong-si (KR); Tae Young CHUNG, Hwaseong-si (KR); Jung Hwi KIM, Hwaseong-si (KR)

(73) Assignees: Hyundai Motor Company, Seoul (KR); Kia Corporation, Seoul (KR)

(21) Appl. No.: 19/246,017

(22) Filed: Jun. 23, 2025

(30) Foreign Application Priority Data
Jul. 1, 2024 (KR) 10-2024-0086249

(51) Int. Cl. H02P 29/62; H01M 10/615; H01M 10/63; H01M 10/667

(52) U.S. Cl. CPC H02P 29/62; H01M 10/615; H01M 10/63; H01M 10/667

(57) ABSTRACT

Proposed is a motor driving apparatus that includes a motor, a first inverter, a second inverter, a mode changeover part including a plurality of mode changeover switches, each including an end connected to the opposite end of each of the plurality of windings and an opposite end interconnected to an opposite end of each of the other mode changeover switches to form a node, a battery, and a controller that applies a zero-phase current to the motor, thereby increasing battery temperature in a state where the opposite end of each of the plurality of windings and the node are electrically separated.

### CROSS REFERENCE TO RELATED APPLICATION

The present application claims priority to Korean Patent Application No. 10-2024-0086249, filed Jul. 1, 2024, the entire contents of which is incorporated herein for all purposes by this reference.

### BACKGROUND

### Technical Field

The present disclosure relates to a motor driving apparatus and method controlling for same. More particularly, the present disclosure relates to a motor driving apparatus and method controlling for same to increase battery temperature through a zero-phase current in an open-end winding approach with inverters respectively connected to a plurality of ends of windings on the associated opposite sides of the motor windings.

### Description of the Related Art

Typically, a winding of each phase in a motor has one end connected to one inverter and an opposite end connected to opposite ends of windings of other phases, forming a Y-connection.

When the motor is driven, changeover elements inside the inverter are turned on and off by pulse width modulation control, applying line voltage to the windings of the Y-connected motor to generate alternating current, thereby generating torque.

The fuel efficiency (or electric power efficiency) of eco-friendly vehicles such as electric vehicles that use the torque generated by such motors as power is determined by the power conversion efficiency of the inverter-motor. Therefore, in order to improve fuel efficiency, it is important to maximize the power conversion efficiency of the inverter and the efficiency of the motor.

The efficiency of an inverter-motor system is primarily determined by the voltage utilization rate of the inverter. When a vehicle's operating point, determined by the relationship between motor speed and torque, is established in a section with a high voltage utilization rate, the vehicle's fuel efficiency may be improved.

Meanwhile, in order to improve fuel efficiency and vehicle's launch acceleration performance, a motor driving technique using an open-end winding (OEW) method has been proposed in the relevant technical field. Instead of shorting the opposite ends of each phase of the motor winding through a Y connection, this technique drives two inverters respectively connected to a plurality of ends of windings on the associated opposite sides of the motor windings.

The motor driving technique using an open-end winding (OEW) method has the advantage of increasing the phase voltage, thereby improving the voltage utilization rate and enabling a higher output compared to a conventional Y-connected motor driving method.

This motor driving technique, which uses an open-end winding method, generates a common mode current due to the zero-phase voltage when a common DC power source is applied to the inverters respectively connected to a plurality of ends of windings on the associated opposite sides of the motor windings.

The foregoing is intended merely to aid in the understanding of the background of the present disclosure and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to provide a motor driving apparatus and method controlling for same which may may increase the battery temperature through a zero-phase current between two inverters when driving a motor using an open-end winding method, the two inverters being respectively connected to a plurality of ends of windings on the associated opposite sides of the motor windings.

The technical aspects to be achieved in the present disclosure are not limited to those mentioned above, and other technical aspects not mentioned will be clearly understood by a person having ordinary skill in the technical field to which the present disclosure belongs from the description below.

In order to achieve the above aspects, according to one aspect of the present disclosure, there may be provided a motor driving apparatus, the apparatus including: a first inverter including an associated terminal connected to an end of each of the plurality of windings, and a second inverter including an associated terminal connected to an opposite end of each of the plurality of windings;
a mode changeover part including a plurality of mode changeover switches, each including an end connected to the opposite end of each of the plurality of windings and an opposite end interconnected to an opposite end of each of the other mode changeover switches to form a node;
a battery electrically connected to both the first inverter and the second inverter; and
a controller that applies a zero-phase current to the motor, thereby increasing battery temperature in a state where the opposite end of each of the plurality of windings and the node are electrically separated, as the plurality of mode changeover switches are turned off.

For example, the controller may apply the zero-phase current to the motor until the battery temperature reaches a preset target temperature.

For example, the motor may be thermally connected to the battery through a coolant line, in which coolant flows, to exchange heat with the battery.

For example, on the basis of battery's characteristics and an allowable range for applying the zero-phase current, the controller may apply the zero-phase current.

For example, the battery's characteristics may include at least one of the battery's impedance and the maximum current that may pass through the battery.

For example, the controller may judge the battery's characteristics on the basis of at least one of the temperature, voltage, and State of Charge (SOC) of the battery.

For example, the controller may judge the allowable range for applying the zero-phase current on the basis of an output of the motor.

For example, considering the battery's characteristics in the allowable range for applying the zero-phase current, the controller may determine frequency and amplitude of the zero-phase current to maximize the current passing through battery's internal resistance and apply the zero-phase current on the basis of determined frequency and amplitude.

In order to achieve the above aspects, according to one aspect of the present disclosure, there may be provided a method controlling for motor driving apparatus, the method including: electrically separating an opposite end of each of a plurality of windings and a node by turning off a plurality of mode changeover switches using a controller; and increasing battery temperature by applying a zero-phase current to a motor using the controller, in a state where the opposite end of each of the plurality of windings and the node are electrically separated; and increasing battery temperature by applying a zero-phase current to a motor using the controller, in a state where the opposite end of each of the plurality of windings and the node are electrically separated.

For example, the increasing the battery temperature may include applying the zero-phase current to the motor using the controller until the battery temperature reaches a preset target temperature.

For example, the motor may be thermally connected to a battery through a coolant line, in which coolant flows, to exchange heat with the battery.

For example, the increasing the battery temperature may further include applying the zero-phase current using the controller on the basis of battery's characteristics and an allowable range for applying the zero-phase current.

For example, the battery's characteristics may include at least one of battery's impedance and maximum current that may pass through the battery.

For example, the method controlling for motor driving apparatus according to one aspect of the present disclosure may further include judging the battery's characteristics on the basis of at least one of the temperature, voltage, and State of Charge (SOC) of the battery using the controller.

For example, the method controlling for motor driving apparatus according to one aspect of the present disclosure may further include judging the allowable range for applying the zero-phase current on the basis of an output of the motor using the controller.

For example, the increasing the battery temperature may further include applying the zero-phase current on the basis of determined frequency and amplitude by determining frequency and amplitude of the zero-phase current to maximize the current passing through battery's internal resistance by considering the battery's characteristics in the allowable range for applying the zero-phase current using the controller.

As described above, according to the motor driving apparatus, the battery temperature is increased by using a zero-phase current that does not affect the torque of the motor, so it is possible to increase the battery temperature not only while a vehicle is stopped but also while the vehicle is driving.

In addition, the volume and cost associated with a separate dedicated circuit for increasing the battery temperature may be reduced.

Furthermore, by increasing the battery temperature, it may be possible to manage the battery within a stable temperature range, thereby improving its output performance, charging performance, and lifespan.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a circuit diagram of a motor driving apparatus according to one embodiment of the present disclosure;

FIG. 2 is a diagram illustrating the changeover of a motor driving mode according to one embodiment of the present disclosure;

FIG. 3 is a block diagram showing a detailed configuration of a controller applied to the motor driving apparatus according to one embodiment of the present disclosure;

FIG. 4 is a drawing illustrating the heat exchange process of the motor driving apparatus according to one embodiment of the present disclosure; and

FIG. 5 is a flowchart illustrating a control method of the motor driving apparatus according to one embodiment of the present disclosure.

### DETAILED DESCRIPTION

Hereinafter, embodiments disclosed in the present specification will be described in detail with reference to the accompanying drawings, but the same or similar components are assigned the same reference numerals regardless of reference numerals, and overlapping descriptions thereof will be omitted. The terms “module” and “part” for the components used in the following description are given or mixed in consideration of only the ease of writing the specification and do not have distinct meanings or roles by themselves. In addition, in describing the embodiments disclosed in the present specification, when it is judged that detailed descriptions of related known technologies may obfuscate the gist of the embodiments disclosed in the present specification, the detailed description thereof will be omitted. In addition, the accompanying drawings are only to aid in easy understanding of the embodiments disclosed in this specification, and the technical idea disclosed herein is not limited by the accompanying drawings, and all changes included in the spirit and scope of the present disclosure should be understood to include equivalents or substitutes.

Terms including ordinal numbers such as first, second, and the like may be used to describe various elements, but the elements are not limited by the terms. The above terms are used only for the purpose of distinguishing one component from another.

When a component is referred to as being “connected” or “coupled” to another component, it may be directly connected or coupled to another component, but it should be understood that other components may exist in between. On the other hand, when a component is referred to as being “directly connected” or “directly connected” to another component, it should be understood that there are no other components in between.

A singular expression includes a plural expression unless the context clearly dictates otherwise.

In the present specification, terms such as “comprises” or “have” are intended to designate that the features, numbers, steps, operations, components, parts, or combinations thereof described in the specification exist and should be understood that it does not preclude the possibility of addition or existence of one or more other features, numbers, steps, operations, components, parts, or combinations thereof.

In addition, a unit or a control unit included in the name of the motor controller unit (MCU) and the like is a term widely used to name a control device (controller) that controls a specific function of a vehicle and does not mean a generic function unit. For example, each controller may include a communication device that communicates with other controllers or sensors to control the function in charge, a memory that stores an operating system or logic commands and input/output information, and one or more processors that perform judgment, calculation, and decision, and the like necessary for controlling the function in charge. The controller according to an exemplary embodiment of the present disclosure may be a hardware device implemented by various electronic circuits (e.g., computer, microprocessor, CPU, ASIC, circuitry, logic circuits, etc.). The controller may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

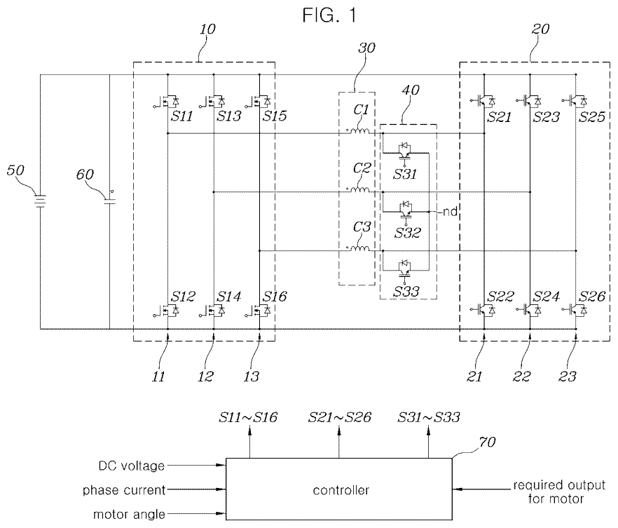

FIG. 1 is a circuit diagram of a motor driving apparatus according to one embodiment of the present disclosure.

With reference to FIG. 1, the motor driving apparatus according to one embodiment may include a first inverter 10, a second inverter 20, a motor 30 including a plurality of windings C1, C2, and C3 corresponding to a plurality of phases, respectively, a mode changeover part 40, a battery 50, a DC capacitor (or DC-Link capacitor) 60, and a controller 70.

The first inverter 10 may include a plurality of first changeover elements S11-S16 connected to associated one end of the plurality of windings C1, C2, and C3, and the second inverter 20 may include a plurality of second changeover elements S21-S26 connected to associated one opposite end of the plurality of windings C1, C2, and C3. The mode changeover part 40 may include a plurality of mode changeover switches S31, S32, and S33. Each of the mode changeover switches S31, S32, and S33 has one end connected to associated one opposite end of the plurality of windings C1, C2, and C3 and one opposite end interconnected to an opposite end of each of the other mode changeover switches to form a node nd. The controller 70 may control on/off states of the first changeover elements S11, S12, S13, S14, S15, and S16, the second changeover elements S21, S22, S23, S24, S25, and S26, and the mode change switches S31, S32, and S33 on the basis of the motor demand output (that is, the torque command for the motor), the DC link voltage of the inverters 10 and 20 (that is, the battery voltage), the phase current of the motor, and the motor angle.

The first inverter 10 may include a plurality of legs 11, 12, and 13 to which a DC voltage provided in a DC capacitor 60 connected between the two terminals of the battery 50 is applied. Each of the legs 11, 12, and 13 may be electrically connected to an associated one of a plurality of phases of the motor 30, respectively.

More specifically, the first leg 11 includes two changeover elements S11 and S12 that are connected in series between the two terminals of the DC capacitor 60, and between the two changeover elements S11 and S12 is connected to one end of the winding Cl of one phase in the motor 30, so that AC power associated with one of the plurality of phases may be input/output. Similarly, the second leg 12 includes two changeover elements S13 and S14 that are connected in series between the two terminals of the DC capacitor 60, and between the two changeover elements S13 and S14 is connected to one end of the winding C2 of one phase in the motor 30, so that AC power associated with one of the plurality of phases may be input/output. In addition, the third leg 13 includes two changeover elements S15 and S16 that are connected in series between the two terminals of the DC capacitor 60, and between the two changeover elements S15 and S16 is connected to one end of the winding C3 of one phase in the motor 30, so that AC power associated with one of the plurality of phases may be input/output.

The second inverter 20 may include a plurality of legs 21, 22, and 23 to which the DC voltage provided in the DC capacitor 60 connected between the two terminals of the battery 50 is applied. Each of the legs 21, 22, and 23 may be electrically connected to an associated one of a plurality of phases of the motor 30, respectively.

More specifically, the first leg 21 includes two changeover elements S21 and S22 that are connected in series between the two terminals of the DC capacitor 60, and between the two changeover elements S21 and S22 is connected to one opposite end of the winding C1 of one phase in the motor 30, so that AC power associated with one of the plurality of phases may be input/output. Similarly, the second leg 22 includes two changeover elements S23 and S24 that are connected in series between the two terminals of the DC capacitor 60, and between the two changeover elements S23 and S24 is connected to one opposite end of the winding C2 of one phase in the motor 30, so that AC power associated with one of the plurality of phases may be input/output. In addition, the third leg 23 includes two changeover elements S25 and S26 that are connected in series between the two terminals of the DC capacitor 60, and between the two changeover elements S25 and S26 is connected to one opposite end of the winding C3 of one phase in the motor 30, so that AC power associated with one of the plurality of phases may be input/output.

The plurality of mode changeover switches S31, S32, and S33 may each have one end connected to the associated one opposite end of the plurality of windings C1, C2, and C3 and one opposite end interconnected to an opposite end of each of the other mode changeover switches to form a node nd. The plurality of mode changeover switches S31, S32, and S33 may adopt various changeover means known in the related art, such as MOSFETs, IGBTs, thyristors, relays, and the like.

Although not shown in FIG. 1, the motor driving apparatus may further include a so-called Y-capacitor (Y-Cap) which is composed of two capacitors connected in series between a positive (+) DC terminal and negative (−) DC terminal and grounded between the capacitors.

The controller 70 may control the motor 30 to be driven by changeover the changeover elements S11, S12, S13, S14, S15, S16, S21, S22, S23, S24, S25, and S26 included in the first inverter 10 and the second inverter 20 through pulse width modulation control on the basis of the required output for the motor 30.

In addition, the controller 70 may control the on/off state of the mode changeover switches S31, S32, and S33 included in the mode changeover part 40 according to the motor driving mode. The motor driving mode may include a first driving mode and a second driving mode. At this time, the first driving mode may be referred to the “Closed End Winding (CEW) mode”, and the second driving mode may be referred to the “Open End Winding (OEW) mode”.

More specifically, when the CEW mode is performed, the controller 70 may control the mode changeover switches S31, S32, and S33 to switch to an ON state and drive the motor 30 through the first inverter 10 of the two inverters 10 and 20. The mode changeover switches S31, S32, and S33 may electrically connect the opposite end of each of the plurality of windings C1-C3 and the node nd when turned on. For example, the node nd provided at the opposite end of the mode changeover switches S31, S32, and S33 becomes the neutral point of the motor 30.

Unlike this, when the OEW mode is performed, the controller 70 may control the mode changeover switches S31, S32, and S33 to switch to an OFF state and drive the motor 30 through two inverters 10 and 20. The mode changeover switches S31, S32, and S33 may electrically separate the opposite end of each of the plurality of windings C1-C3 and the node nd for the plurality of windings C1-C3 in the off state. For example, the node nd, interconnected at the opposite end of each of the mode changeover switches S31, S32, and S33, does not serve as the neutral point of the motor 30, and the motor 30 is connected to both the first inverter 10 and the second inverter 20.

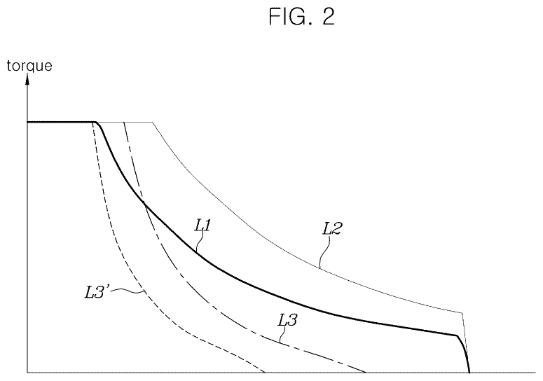

FIG. 2 is a diagram illustrating switching of a motor driving mode according to one embodiment of the present disclosure.

With reference to FIG. 2, the motor's operating point map is shown, the map depicting the output limit curve L1 of the CEW mode, the output limit curve L2 of the OEW mode, and the mode changeover reference line L3 based on an efficiency map.

The output limit curves L1 and L2 may each represent the output torque limit of the motor for each motor rotation speed (for example, RPM) in a corresponding motor driving mode. The output limit curve L2 has an output limit higher than the output limit curve L1 in at least some RPM range, and the output limit curves L1 and L2 may be set by considering the durability, heat generation, and current controllability of the motor and inverter.

The mode changeover reference line L3 based on the efficiency map (not shown) may correspond to the boundary between the high efficiency area of the CEW mode and the high efficiency area of the OEW mode. The efficiency map may contain information on which mode—CEW or OEW—has higher efficiency for each combination of motor torque and reverse flux and may be presented in table form, depending on the implementation. For example, the efficiency map may be derived on the basis of the results of testing to measure motor loss according to the rotation speed and torque of the motor in each motor driving mode for each DC link voltage of the inverter. At this time, the reverse magnetic flux of the motor may be inversely proportional to the DC link voltage of the inverter (that is, the battery voltage) and directly proportional to the motor speed.

According to the embodiment, the mode changeover reference line L3 may have a shape such as L3′ depending on the specifications of the motor driving apparatus. However, the mode changeover reference lines L3 and L3′ illustrated in FIG. 2 are exemplary and are not necessarily limited thereto.

The controller 70 may switch between CEW mode and OEW mode in both directions on the basis of the torque command value and reverse magnetic flux of the motor, referring to the efficiency map to change the motor driving mode according to the mode changeover reference line L3. At this time, the reverse magnetic flux value may be calculated on the basis of the motor's torque command, the inverter's DC link voltage, and the required motor speed. According to the embodiment, the controller 70 may correct the mode changeover reference line by considering output limits or hysteresis for the motor driving mode. For example, the motor driving mode may be switched according to the value of the torque command for the motor and the value of the reverse magnetic flux on the basis of the corrected mode changeover reference line.

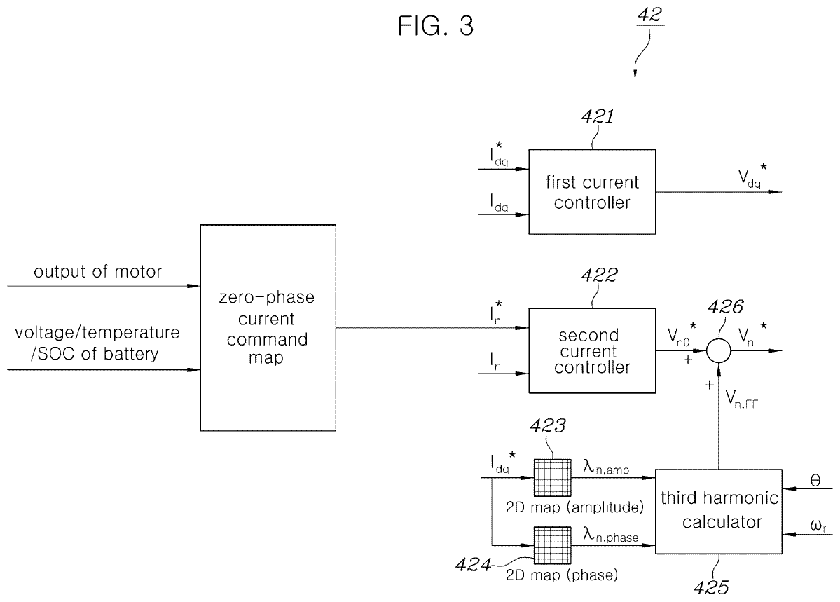

FIG. 3 is a block diagram showing a detailed configuration of the controller applied to the motor driving apparatus according to one embodiment of the present disclosure.

The controller 70 may include a zero-phase current command map 41 and a current controller 42, wherein the current controller 42 may be configured to include a first current controller 421, a second current controller 422, a first data map 423, a second data map 424, a third harmonic calculator 425, and an adder 426.

The first current controller 421 may compare a dq-axis current command I_{dq}* determined by the current command map 41 with a dq-axis current I_{dq} flowing in the motor 100 and generate a dq-axis voltage command V_{dq}* of the motor for reducing the error thereof.

The dq-axis current I_{dq} flowing in the motor 30 may be obtained by converting the value of the current flowing in the winding of each phase of the motor detected by a current sensor and the like into the form of the dq-axis current by converting the rotation angle θ of the motor into dq coordinates. A technique of converting the abc coordinates including the a-axis, b-axis, and c-axis corresponding to each phase of the motor into the d-axis and q-axis coordinates (Clarke/Park Transformation) and a technique of converting in the opposite direction (Inverse Clarke/Park Transformation) are well-known techniques in the related art, so a separate explanation will be omitted.

The first current controller 421 may be implemented in various forms such as a proportional integral (PI) controller, a proportional (P) controller, an integral (I) controller, and the like and may be implemented as a PI controller.

The second current controller 422 may compare the zero-phase current command Iₙ* of the motor and the zero-phase current Iₙ flowing in the motor 30 and generate a voltage value Vn₀* for reducing the error thereof.

The zero-phase current Iₙ flowing in the motor 30 may be obtained by converting the value detected by a current sensor or the like from the current flowing in the winding of each phase of the motor using rotation conversion.

The second current controller 422 may be implemented in various forms such as a proportional integral (PI) controller, a proportional (P) controller, an integral (I) controller, and the like.

The third harmonic calculator 425 may calculate the third harmonic components in the motor's zero-phase voltage on the basis of the motor's rotation angle θ, rotation speed ωᵣ, zero-phase magnetic flux amplitude λ_{n,amp}, and zero-phase magnetic flux phase λ_{n,phase}.

The third harmonic components, calculated by the third harmonic calculator 425, are added to the output value Vₙ₀ of the second current controller 422 by the adder 426, thereby performing forward compensation. That is, the sum of the output value Vₙ₀* of the second current controller 422 and the output value V_{n,FF} from the third harmonic calculator 425, calculated by the adder 426, may become the zero-phase voltage command value Vₙ, used for pulse width modulation control of the motor.

Meanwhile, the amplitude λ_{n,amp} and the phase λ_{n,amp} of the motor's zero-phase flux may be determined by the data maps 423 and 424.

In addition, the zero-phase current command In* may take the output (required torque and speed) of the motor 30, the voltage, temperature, and SOC of the battery 50 as input values and be determined through a zero-phase current command map that generates the zero-phase current command In* corresponding to the input values.

Meanwhile, the motor driving apparatus according to one embodiment of the present disclosure applies a zero-phase current that does not affect the torque to the motor 30 when the plurality of mode changeover switches S31, S32, and S33 is turned off and the opposite end of each of the plurality of windings C1, C2, and C3 and the node are electrically separated, that is in the OEW mode, thereby increasing the temperature of the battery 50. Through this, the battery may be managed within an appropriate temperature range even during driving while reducing the volume and cost associated with increasing the battery temperature.

For example, the controller 70 may apply zero-phase current to the motor 30 until the temperature of the battery 50 reaches a preset target temperature.

In particular, the controller 70 may apply zero-phase current to the motor 30 on the basis of the battery's characteristics and the allowable range for applying the zero-phase current. For this purpose, the zero-phase current command map 41 may be referenced.

More specifically, the characteristics of the battery 50 may include at least one of the impedance of the battery 50 and the maximum current that can pass through the battery. These characteristics may be determined on the basis of at least one of the battery temperature, voltage, and SOC. Such characteristics may be judged through experimental values for the temperature, voltage, and SOC behavior of the battery 50, and these experimental values may be reflected in the zero-phase current command map 41.

In addition, the allowable range for applying the zero-phase current may be determined on the basis of the output (required torque and speed) of the motor 30. it becomes necessary to secure the d- and q-axis currents to generate torque. As a result, the range in which the zero-phase current may be used to increase the temperature of the battery 50 becomes limited.

Furthermore, the controller 70 may synthesize this information and, by considering the battery's characteristics in the allowable range for applying the zero-phase current, determine the frequency and amplitude of the zero-phase current. This ensures that the current passing through battery's internal resistance is maximized. The controller may then generate a zero-phase current command, In*, to apply the zero-phase current according to the determined frequency and amplitude.

For example, by applying the zero-phase current while considering the impedance of the battery 50, it is possible to judge the frequency that maximizes the amplitude of the zero-phase current under the current battery conditions. As the amplitude of the applied zero-phase current increases, the current passing through the battery's internal resistance also increases, thereby generating more heat within the battery 50.

Meanwhile, in one embodiment, the temperature of the battery 50 may increase not only due to its own heat generation but also from the heat generated by the motor 30, which is thermally connected to it.

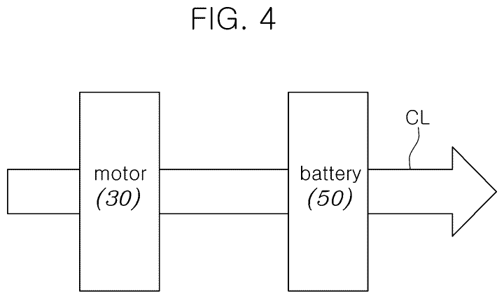

This will be explained with reference to FIG. 4.

FIG. 4 is a drawing illustrating a heat exchange process of the motor driving apparatus according to one embodiment of the present disclosure.

With reference to FIG. 4, the motor 30 may be thermally connected to the battery through a coolant line (CL) in which coolant for heat exchange with the battery 50 flows inside. That is, the motor 30 and the battery 50 may share the coolant line (CL). When the motor 30 is located ahead of the battery 50 in the coolant flow of the coolant line (CL) as shown in FIG. 4, the heat generated in the motor 30 may be transferred to the battery 50 through the coolant, and as a result, the temperature of the battery 50 may be increased. In particular, since the motor 30 generates heat when zero-phase current is applied, the temperature of the battery 50 may increase as the generated heat is transferred through the cooling water line (CL).

Meanwhile, FIG. 4 shows the primary elements necessary to explain one embodiment. Additional components may be present between the motor 30 and the battery 50, as well as at their front and rear ends. In such cases, these components may also serve as heat sources.

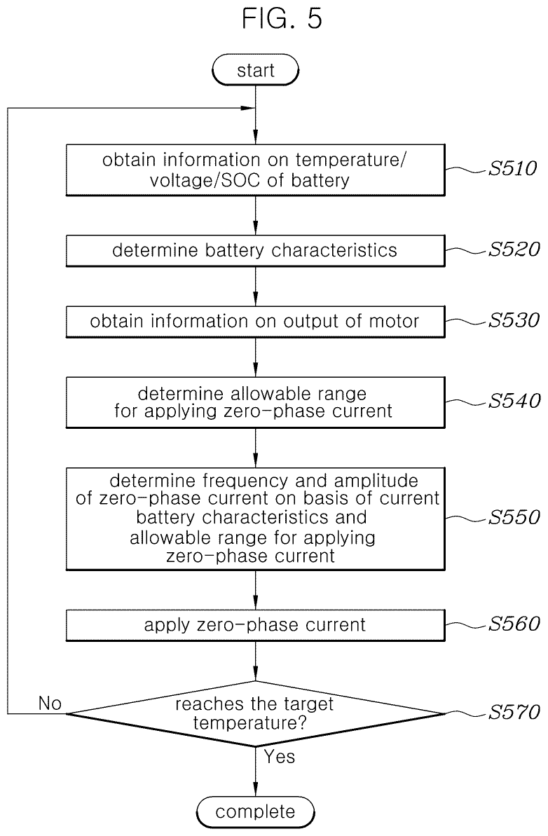

Hereinafter, a method for controlling a motor driving apparatus according to one embodiment of the present disclosure will be described with reference to FIG. 5.

With reference to FIG. 5, first, the controller 70 may obtain information on the temperature/voltage/SOC of the battery 50 in S510, and such information may be provided from a battery management system (BMS) equipped in the vehicle. On the basis of the obtained information, the controller 70 may judge battery characteristics, such as the impedance of the battery 50 and the maximum current that can pass through it, in S520.

In addition, the controller 70 may obtain information on the output of the motor 30, such as the required torque and speed, in S530. This information may be provided by a controller installed in the vehicle that controls the motor or by an upper-level controller that manages it. On the basis of the obtained information, the controller 70 may then judge the allowable range for applying the zero-phase current in S540.

Afterwards, on the basis of the currently judged battery characteristics and the allowable range for applying the zero-phase current, the controller 70 may determine the frequency and amplitude of the zero-phase current in S550. For example, the frequency and amplitude of the zero-phase current may be determined to maximize the current passing through the internal resistance of battery 50.

The controller 70 may generate a zero-phase current command according to the frequency and amplitude of the determined zero-phase current and apply the zero-phase current in S560. When the temperature of the battery 50 reaches the target temperature due to the application of the zero-phase current (if the condition in S570 is met), one cycle of increasing the battery temperature is complete. When the temperature of the battery 50 does not reach the target temperature (when the condition in S570 is not met), the entire process is repeated.

In the motor driving apparatus, zero-phase current, which does not affect motor torque, may be used to increase the battery temperature, allowing its temperature to increase both when the vehicle is stopped and while driving.

In addition, the volume and cost associated with a separate dedicated circuit for increasing the battery temperature may be reduced.

Although a various embodiments of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A motor driving apparatus, the apparatus comprising:
a motor including a plurality of windings;
a first inverter connected to an end of each of the plurality of windings
a second inverter connected to an opposite end of each of the plurality of windings;
a mode changeover part including a plurality of mode changeover switches, each including an end connected to the opposite end of each of the plurality of windings and an opposite end interconnected to form a node;
a battery electrically connected to both the first inverter and the second inverter; and
a controller configured to apply a zero-phase current to the motor to increase the temperature of the battery in a state where the opposite end of each of the plurality of windings and the node are electrically separated, as the plurality of mode changeover switches are turned off.

2. The apparatus of claim 1, wherein the controller is configured to apply the zero-phase current to the motor until the temperature of the battery reaches a preset target temperature.

3. The apparatus of claim 1, wherein the motor is thermally connected to the battery through a coolant line, in which coolant exchanging heat with the battery flows.

4. The apparatus of claim 1, wherein, the controller is configured to apply the zero-phase current, based on battery's characteristics and an allowable range for applying the zero-phase current.

5. The apparatus of claim 4, wherein the battery's characteristics comprise:
one or more of the battery's impedance and the maximum current that may pass through the battery.

6. The apparatus of claim 5, wherein the controller is configured to determine the battery's characteristics based on one or more of the temperature, voltage, and State of Charge (SOC) of the battery.

7. The apparatus of claim 4, wherein the controller is configured to determine the allowable range for applying the zero-phase current based on an output of the motor.

8. The apparatus of claim 4, wherein the controller is configured to determine frequency and amplitude of the zero-phase current to maximize the current passing through battery's internal resistance based on the battery's characteristics in the allowable range of applying the zero-phase current and to apply the zero-phase current based on the determined frequency and amplitude.

9. A method for controlling a motor driving apparatus comprising a motor including a plurality of windings, a first inverter connected to an end of each of the plurality of windings, a second inverter connected to an opposite end of each of the plurality of windings, a mode changeover part including a plurality of mode changeover switches, each including an end connected to the opposite end of each of the plurality of windings and an opposite end interconnected to form a node and a battery electrically connected to both the first inverter and the second inverter, the method comprising:
electrically separating the opposite end of each of the plurality of windings and a node by turning off the plurality of mode changeover switches by a controller; and
increasing temperature of the battery by applying a zero-phase current to the motor by the controller, in a state where the opposite end of each of the plurality of windings and the node are electrically separated.

10. The method of claim 9, wherein the increasing comprises:
applying the zero-phase current to the motor until the temperature of the battery reaches a preset target temperature.

11. The method of claim 9, wherein the motor is thermally connected to a battery through a coolant line, in which coolant exchanging heat with the battery flows.

12. The method of claim 9, wherein the increasing further comprises:
applying the zero-phase current based on battery's characteristics and an allowable range of applying the zero-phase current.

13. The method of claim 12, wherein the battery's characteristics comprise:
one or more of battery's impedance and maximum current that may pass through the battery.

14. The method of claim 13, further comprising:
determining the battery's characteristics based on one or more of the temperature, voltage, and State of Charge (SOC) of the battery by the controller.

15. The method of claim 12, further comprising:
determining the allowable range of applying the zero-phase current based on an output of the motor by the controller.

16. The apparatus of claim 12, wherein the increasing further comprises: determining frequency and amplitude of the zero-phase current to maximize the current passing through battery's internal resistance based on the battery's characteristics in the allowable range of applying the zero-phase current, and
applying the zero-phase current based on the determined frequency and amplitude.
